(19) United States
(12) Patent Application Publication
(10) Pub. No.: US 2019/0021928 A1
(43) Pub. Date: Jan. 24, 2019

(54) Bedpan Housing

(71) Applicants: Jordan Muen Lee, Newton, MA (US); Michael Andrew Morgan, Cincinnati, OH (US)

(72) Inventors: Jordan Muen Lee, Newton, MA (US); Michael Andrew Morgan, Cincinnati, OH (US)

(73) Assignee: Emleorate Corp., Westwood, MA (US)

(21) Appl. No.: 15/974,142

(22) Filed: May 8, 2018

Related U.S. Application Data
(60) Provisional application No. 62/535,548, filed on Jul. 21, 2017.

(51) Int. Cl. A61G 9/00

(52) U.S. Cl. CPC A61G 9/003

(57) ABSTRACT

A bedpan housing is provided. The bedpan housing has a base, sidewalls and a top surface that a user may rest their body on. The bedpan housing defines an open front through which a bedpan may pass. In use, the bedpan housing may allow the bedpan to be properly positioned for use and removed after use without excess interference by a patient using the bedpan.

### BACKGROUND OF THE INVENTION

### Field of the Invention

The present invention relates generally to bedpan accessories. More particularly the present invention relates to a bedpan housing device.

### Description of Related Art

Bedpans are used in hospitals and other care situations for those who are unable to use the bathroom. These bedpans are prone to spillage, causing further discomfort and embarrassment for patients. Further, inconvenient bedpans add to wasted time and resources for nurses and care takers. Primary causes of spillage are improper placement of the bedpan and spills during removal. Common bedpans have a relatively tall profile and narrow opening. This leads to patients missing the opening when not placed just right. Removal of the bedpan is also difficult because bedpans can often stick to the patient. Patient weight adds to challenges, causing deformation of the bed pan, and/or the difficulty that caretakers often need to tilt the bedpan to pull it out from under the patient.

Therefore, what is needed is a device that may efficiently and easily facilitate positioning and removal of bedpans.

### SUMMARY OF THE INVENTION

The subject matter of this application may involve, in some cases, interrelated products, alternative solutions to a particular problem, and/or a plurality of different uses of a single system or article.

In one aspect, a bedpan housing is provided. The bedpan housing has a body having a base, a rear, and two sidewalls. The base and two sidewalls define a front opening sized to receive a bedpan. The bedpan housing further has a top surface connected to the sidewalls. The top surface has a buttocks portion adjacent to the rear, and two leg portions. This top surface defines a top opening into a cavity which is defined by the base, rear, and two sidewalls. The bedpan housing is adapted to removably receive the bedpan into the cavity through the front opening such that an opening of the bedpan is aligned with the top opening of the bedpan housing.

### BRIEF DESCRIPTION OF THE DRAWINGS

FIG. 1 provides a perspective view of an embodiment of the bedpan housing.

FIG. 2 provides an elevation view of another embodiment of the bedpan housing.

FIG. 3 provides a side view of an embodiment of the bedpan housing.

FIG. 4 provides a front view of another embodiment of the bedpan housing.

FIG. 5 provides a rear view of yet another embodiment of the bedpan housing.

FIG. 6 provides a perspective view of still another embodiment of the bedpan housing receiving a bedpan.

FIG. 7 provides a perspective view of still another embodiment of the bedpan housing having a bedpan positioned within.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a bedpan housing that is able to receive a bedpan, such as a fracture bedpan, via a front opening. Once used, the bedpan can easily be removed from the housing through the front opening while the bedpan housing remains in place and bears the weight of the user. Such a structure greatly aids in limiting spillage when using and removing the bedpan.

The bedpan housing is formed generally of a base, side walls, and a top seating area. These define a top opening and a front opening, the front opening sized to removably receive a bedpan, and the top opening large enough to communicate with the basin opening of the bedpan. The bedpan housing is constructed to be able to be able to support a weight of a user without appreciable deformation that would apply a force against the bedpan, thereby allowing the bedpan to be easily removed from the housing while the weight of the user is supported by the bedpan housing. Any deformation of the bedpan housing caused by the weight of a user is minimal and not appreciable such that it does not interfere with an ability of the bedpan to be removed, with at most only slight frictional contact between the bedpan and bottom face of the top surface. In one embodiment, the bedpan housing may withstand a load of up to 500 lb. without appreciable deformation to interfere with entry or removal of the bedpan. In a further embodiment, the bedpan housing may deform approximately 6 mm under a 450 lb load, which is not appreciable deformation to prevent entry or removal of a bedpan into the cavity. The bedpan housing, which does not receive any waste, may be removed from under a user after the bedpan is removed. In one embodiment, all top edges of the housing may be rounded to limit risk of discomfort, and all bottom edges of the housing may be rounded to facilitate ease of placement.

Materials of which the bedpan housing may be made include, but are not limited to plastic materials, metals, wood, composite materials, ceramics, combinations of these materials, and the like.

The bedpan housing may be of various sizes to fit various sizes and types of bedpans. In many cases, an embodiment of the bedpan housing may be sized to receive what is known in the art as a “fracture bedpan.” Fracture bedpans are common, small, tapered bedpans which are designed to be slid underneath a patient with a hip fracture, but can be used for any bedridden patient. In other cases, the bedpan housing may be large enough to receive a variety of different bedpans in a single housing. A spacer may be built into the housing or removably positioned therein to properly position a bedpan within the housing.

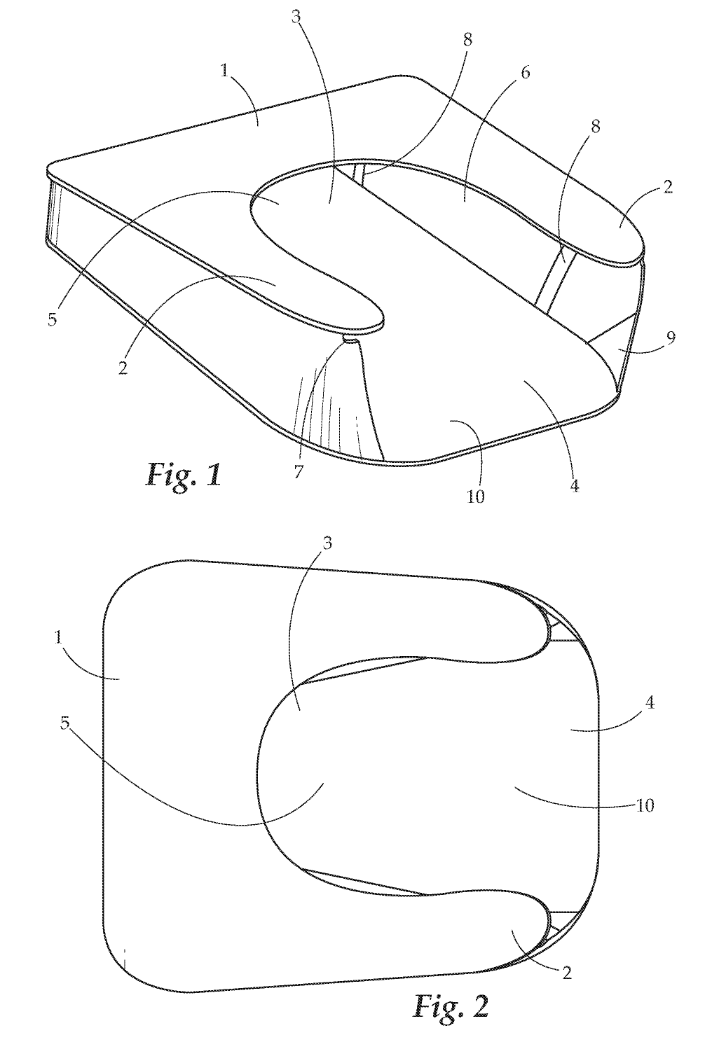

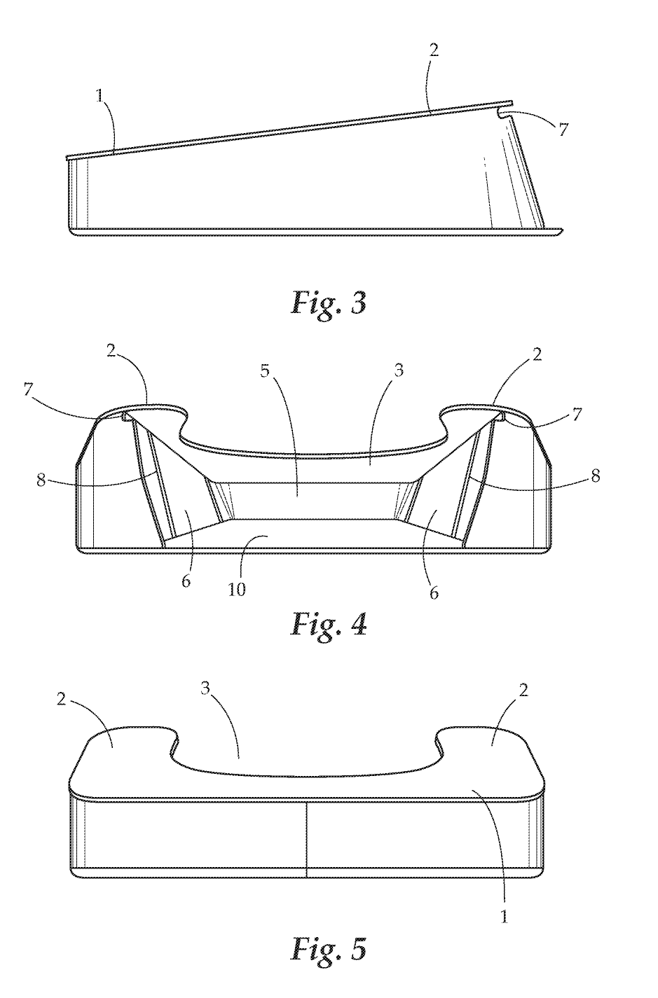

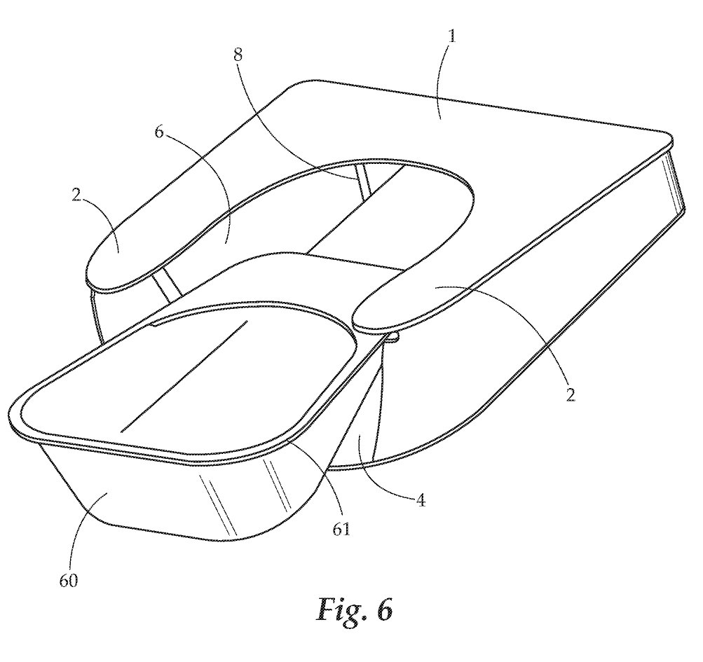

Turning now to FIGS. 1-5, views of certain embodiments of the bedpan housing are provided. The bedpan housing is formed of a base 10, sidewalls 6, and a seating area formed of a flat buttocks portion 1 and a legs portion 2. In some embodiments, the leg portion can be flat, or may slope upwardly as shown in the FIG. 1. Similarly, in other embodiments the buttocks portion 1 may be flat, or curved. Embodiments having upward sloping legs portions 2 may be more comfortable and may ease use of the bedpan and housing. However, it should be understood that the present invention is in no way limited to such shapes. The seating area opens at its center to create a top opening 3 through which waste may enter into a bedpan. In this embodiment, the top surface buttocks portion 1 and legs portion 2 combine to define an approximately U shaped top surface.

The bedpan housing has a front opening 4 which allows a bedpan to be positioned within the housing and removed from the housing through the front opening. The legs portion 2 extends to the front opening so that the user's legs are shielded from the bedpan and do not unintentionally interfere with the bedpan during removal. In some cases, slight overlap of the legs portion 2 extends past the front edge of the sidewalls 6 and/or base 10. Optionally, the bedpan housing may have reinforcing struts 8 or other structural elements to strengthen the bedpan housing and support the seating area. Further, in some optional embodiments, the sidewalls may taper forward at the front edge, forming an inward protrusion 9. Further still, in some optional embodiments, the sidwewalls may define a slot 7 into which a flange of a bedpan (not shown) may slidably fit. This structure may allow the bed pan to be at least partially secured in position during use.

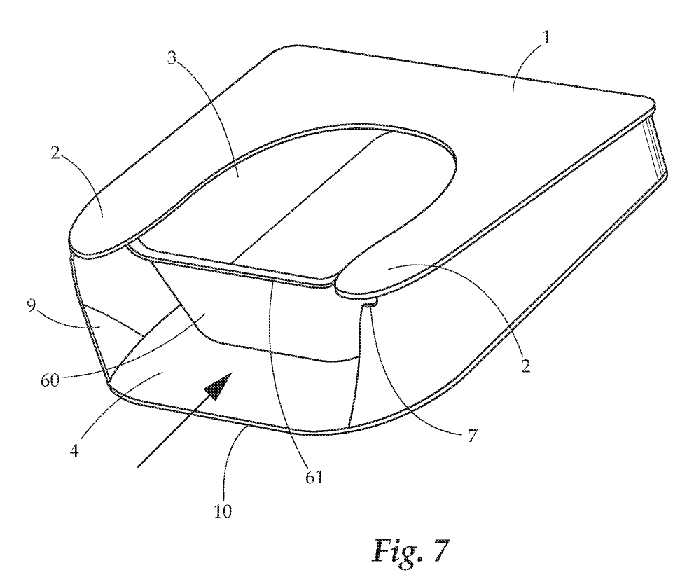

FIGS. 6 and 7 show views of embodiments of the bedpan housing in operation. Here, the bedpan top surface leg portions 2 and buttocks portion 1 are seen above the top of the bedpan 60. The bedpan 60 may abut a bottom face of the top surface, or may be spaced apart from it. Any deformation of the bedpan housing caused by the weight of a user is minimal such that it does not interfere with an ability of the bedpan 60 to be removed, with at most only slight frictional contact between the bedpan 60 and bottom face of the top surface 1, 2. As seen in FIG. 6, a bedpan 60 is formed having a tapering height, with a leading edge buttocks portion shorter than the opposite end by the front opening. The bedpan 60 defines an opening which allows access to a basin. The bedpan 60 opening should align with the opening 3 of the bedpan housing. As is clear from the figures, the bedpan top surface 1, 2, provides a greater seating area than the bedpan top surface area itself, minimizing pressure applied to a user.

In this embodiment, a flange 61 of the bedpan 60 engages with the slot 7. In this view, the bedpan 60 is slid into the bedpan housing via the front opening 4. The bedpan may be manually positioned, or slid in until it abuts an interior rear of the bedpan housing, spacer, or the like. As seen in FIG. 7, this embodiment of the bedpan housing is sized so that the entire bedpan 60 fits within the cavity 5. In some embodiments, a positioning spacer may be used such as protrusions, detents, blocks, and so on, to aid in proper positioning of the bedpan 60 within the cavity 5 of the bedpan housing. As can be seen, in operation, the bedpan housing may be positioned beneath a user such that their buttocks is on the buttocks portion 1, and each leg is on each leg portion 2 of the top surface. Next, a bedpan 60 may be positioned within the cavity 5 of the bedpan housing. A user may use the bedpan, and once finished, the bedpan may be removed via the front opening 4 and between the patient's legs without contacting the user and without forces being applied to it by the user's weight. The bedpan is able to slide out smoothly because it is to have minimal contact with the patient when removed, so no sticking or tilting will result. Once the bedpan is removed, the bedpan housing may be removed from under the user without concern of spilling waste.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A bedpan housing comprising:
a body defining the bedpan housing having a base, a rear, and two sidewalls, the base and two sidewalls defining a front opening sized to allow passage of a bedpan;
a top surface connected to the sidewalls, the top surface having a buttocks portion adjacent to the rear, and two upwardly sloping leg portions, the top surface defining a top opening into a cavity defined by the base, rear, and two sidewalls; and
wherein the bedpan housing is adapted to removably receive the bedpan into the cavity through the front opening such that an opening of the bedpan is aligned with the top opening of the bedpan housing.

2. The bedpan housing of claim 1 wherein the bedpan housing is constructed to receive a 450 lb load on the top surface without appreciable deformation.

3. The bedpan housing of claim 1 wherein the top opening is defined by the top surface having a U-shape.

4. The bedpan housing of claim 1 wherein the two sidewalls extend at an angle away from the base.

5. The bedpan housing of claim 1 wherein at least one of the two sidewalls and the rear wall comprise a reinforcing strut.

6. The bedpan housing of claim 1 wherein at least one of the two sidewalls defines a channel, the channel adapted to receive a flange of the bedpan.

7. The bedpan housing of claim 1 wherein the legs portion extends at an upward angle from the buttocks portion.

8. The bedpan housing of claim 1 wherein the cavity is sized to receive and contain an entire bedpan.

9. The bedpan housing of claim 1 wherein the body tapers inward in width from the front opening to the rear.

10. The bedpan housing of claim 1 wherein the body tapers downward in height from the front opening to the rear.

11. A bedpan housing assembly comprising:
a body defining the bedpan housing having a base, a rear, and two sidewalls, the base and two sidewalls defining a front opening sized to allow passage of a bedpan;
a top surface connected to the sidewalls, the top surface having a buttocks portion adjacent to the rear, and two upwardly sloping leg portions, the top surface defining a top opening into a cavity defined by the base, rear, and two sidewalls; and
the bedpan removably positioned in the cavity such that an opening of the bedpan is aligned with the top opening of the bedpan housing.

12. The bedpan housing assembly of claim 11 wherein the bedpan housing is constructed to receive a 450 lb load on the top surface without deformation that causes the top surface to contact the bedpan.

13. The bedpan housing assembly of claim 11 wherein each of a plurality of top edges and bottom edges of the bedpan housing are rounded.

14. The bedpan housing assembly of claim 11 wherein the two sidewalls extend at an angle away from the base.

15. The bedpan housing assembly of claim 11 wherein at least one of the two sidewalls and the rear wall comprise a reinforcing strut.

16. The bedpan housing assembly of claim 1 wherein at least one of the two sidewalls defines a channel, the channel adapted to receive a flange of the bedpan.

17. The bedpan housing assembly of claim 11 wherein the top surface has a greater seating area than a top surface area of the bedpan.

18. The bedpan housing assembly of claim 11 wherein the cavity contains the entire bedpan.

19. The bedpan housing assembly of claim 11 wherein the body tapers inward in width from the front opening to the rear.

20. The bedpan housing assembly of claim 11 wherein the body tapers downward in height from the front opening to the rear.
